(19) United States
(12) Patent Application Publication
(10) Pub. No.: US 2021/0283943 A1
(43) Pub. Date: Sep. 16, 2021

(54) Writing implement comprising an intermediate piece

(71) Applicant: h & m gutberlet gmbh, Nürnberg (DE)

(72) Inventor: Michael Gutberlet, Nürnberg (DE)

(21) Appl. No.: 16/317,849

(22) PCT Filed: Jul. 10, 2017
(86) PCT No.: PCT/EP2017/067218

§ 371 Date: Jan. 15, 2019

(30) Foreign Application Priority Data
Jul. 20, 2016 (DE) 20 2016 103 934.7

(51) Int. Cl. B43K 23/06; B43K 23/12

(52) U.S. Cl. CPC B43K 23/06; B43K 23/12

(57) ABSTRACT

A writing implement has a casing body to which a grip member is connected, which is turn provided with a writing tip. The writing implement further has a protective cap. The casing body has an externally threaded portion for screwing down the protective cap into a writing position and an internally threaded portion to be connected to the grip member. An intermediate piece having a length L_{ZS} is used to extend a length of the writing implement between the casing body and the grip member, wherein the intermediate piece is connectable to the casing body and to the grip member. As a result, a writing implement is obtained by means of which a handling of the writing implement for a user can be improved with low effort. Another design of a writing implement has a casing body, with a respective writing tip being connected to each of its two sides, wherein the writing implement has two interconnected grip members, with each of the grip members being provided with a respective one of the writing tips.

### CROSS-REFERENCES TO RELATED APPLICATIONS

This a national stage application of International Application PCT/EP2017/067218, filed Jul. 10, 2017, which claims the priority of German Utility Model Application, Serial No. DE 20 2016 103 934.7, filed Jul. 20, 2016, the content of which is incorporated herein by reference in its entirety as if fully set forth herein.

### TECHNICAL FIELD

The invention relates to a writing implement comprising an intermediate piece and to a kit consisting of a writing implement and at least one intermediate piece.

### BACKGROUND

Writing implements are known from prior art through prior public use. A prior art example is disclosed in the specification DE 20 2012 000 422 U1. Document DE 94 12 696 U1 discloses a ballpoint pen comprising a casing intermediate piece for storing a data carrier. Document DE 298 05 183 U1 discloses various embodiments of writing implements comprising a holding sleeve surrounding an intermediate piece, which is in turn provided with a writing tip being formed thereon. On May 4, 2016, a pen referred to as “Kaweco SUPRA fountain pen” was advertised for on the web page www.kaweco-pen.com, saying that it was possible, by means of the additionally supplied intermediate piece, to extend an entire fountain pen by a total of 3 cm. The drawback of many conventional writing implements is that the handling of the writing implement is not optimal for every user.

### SUMMARY

An object of the present invention is to provide a writing implement that allows the user to improve the handling thereof with little effort.

This object is achieved by a writing implement comprising a casing body, a grip member connected to the casing body, a writing tip arranged on the grip member, and a protective cap, wherein the casing body has an externally threaded portion for screwing down the protective cap into a writing position, and an internally threaded portion to be connected to the grip member, and an intermediate piece having a length is provided for extending a length of the writing implement between the casing body and the grip member, the intermediate piece being connectable to the casing body and to the grip member.

It was recognized according to the invention that the handling of the writing implement can be improved for the user by varying the length of the writing implement. In a writing implement according to the invention, the total length of the writing implement can be extended, on the one hand, by screwing the protective cap into the writing position on the second externally threaded portion of the casing body and, on the other, by inserting an intermediate piece between the casing body and the grip member. This allows the length of the writing implement to be varied to different extents, thus allowing the length thereof to be adjusted to the size of the user's hand. This results in an improved handling of the writing implement for the user. The writing implement is preferably configured as a fountain pen.

The writing implement can be equipped with a respective writing tip on each of its two sides, wherein the writing tip may in each case be provided with a protective cap. In this case, the casing body is configured as a second writing tip with an associated protective cap. In a design of this type with a writing tip provided on either side, the length of the intermediate piece is adjusted such that a writing implement is obtained again that offers an improved user handling.

Depending on the user's choice, the intermediate piece may be provided between the casing body and the grip member, on the casing body in the writing position or between the casing body and the protective cap. The positioning of the intermediate piece not only allows the length L_{SG} of the writing implement to be varied but also the position of its center of gravity.

Preferably the externally threaded portion of the casing body is arranged such that when the protective cap is screwed down into the writing position, it covers at least a portion of the casing body.

In a preferred embodiment, the writing implement has a length L_{SG}, the casing body has a length L_{GK}, the grip member has a length L_{GS} and the protective cap has a length L_{SK}, with L_{GS}<L_{GK}, L_{GS}<L_{SK}, and L_{SK}≤L_{GK}.

In another preferred embodiment, more than one intermediate piece is provided. Preferably, a plurality of intermediate pieces are provided between the casing body and the grip member, with at least two intermediate pieces being arranged adjacent to each other.

In another preferred embodiment comprising a plurality of intermediate pieces, the intermediate pieces are configured such as to have an identical design. Consequently, a writing implement is provided that is cheap to produce.

In an alternative embodiment comprising a plurality of intermediate pieces, the length of at least one intermediate piece varies with respect to at least another intermediate piece. This results in an even more improved individual adjustment of the handling of the writing implement for the user.

In particular, the writing implement may consist of a material such as aluminum, brass, copper, stainless steel or hard rubber. Suitable colors include black, silver, natural brass or the like. As an alternative to a monochrome writing implement, the writing implement may also have a color pattern. The surface of the writing implement may be smooth or corrugated.

In a writing implement, in which the length of the intermediate piece is at least 10% of a length of the casing body, the variation of the length is improved even more. In particular, the length L_{ZS} of the intermediate piece corresponds to at least 20%, in particular at least 40%, in particular at least 60% of the length L_{GK} of the casing body.

A writing implement, in which the intermediate piece has a first internally threaded portion to be connected to the grip member, a second internally threaded portion, arranged opposite to the first internally threaded portion, to be connected to the casing body, and an externally threaded portion to be connected to the protective cap in a protective position or another intermediate piece provides an embodiment of the intermediate piece that has an advantageous design.

A writing implement, in which the casing body has a diameter, the protective cap has a diameter and the at least one intermediate piece has a diameter and wherein the following applies: D_{GK}<D_{ZS}, and D_{SK}=D_{ZS}, provides an embodiment of the writing implement that has an elegant appearance and a simple design.

In an embodiment of the writing implement, in which the casing body has a first externally threaded portion for screwing up the protective cap into a protective position, wherein the externally threaded portion for screwing down the protective cap into a writing position is a second externally threaded portion arranged opposite the first externally threaded portion, the casing body has two externally threaded portions, wherein one of these externally threaded portions, hereinafter referred to as first externally threaded portion, is used to screw the protective cap into a protective position while the other externally threaded portion for screwing the protective cap into a writing position is hereinafter referred to as second externally threaded portion. The first externally threaded portion of the casing body may be arranged such that the protective cap screwed into the protective position covers the writing tip.

When using an intermediate piece, the externally threaded portion of the grip member engages the first internally threaded portion of the intermediate piece while the first externally threaded portion of the casing body engages the second internally threaded portion of the intermediate piece.

In another advantageous embodiment, the second externally threaded portion of the casing body engages the second internally threaded portion of the intermediate piece while the externally threaded portion of the intermediate piece engages the internally threaded portion of the protective cap, with the result that the center of gravity is moved in the direction of the protective cap in the writing position.

In another advantageous embodiment, the second externally threaded portion of the casing body engages the second internally threaded portion of the intermediate piece.

When using at least two intermediate pieces, the adjustment of the handling of the writing implement is improved even more for the user. In this case, an externally threaded portion of the grip member engages a first internally threaded portion of a first intermediate piece, an externally threaded portion of at least another intermediate piece engages the internally threaded portion of the previous intermediate piece, and a first externally threaded portion of the casing body engages a second internally threaded portion of the last intermediate piece.

The object stated above is further achieved by a writing implement having a casing body, with a respective writing tip being connected to each of its two sides, wherein the writing implement has two detachably connected grip members, with each of the grip members being provided with a respective one of the writing tips.

It was recognized according to the invention that the handling of the writing implement, in particular an increased flexibility of the possibilities of using the writing implement, can be improved by a double-tip pen design. In a double-tip pen design of this type, the casing body of the writing implement is provided with a second writing tip to which a protective cap may be associated. In this embodiment, the two writing tips can be configured as different pen types, wherein two pen types may in particular be selected from the following possibilities: fountain pen, ballpoint pen, rollerball pen, felt-tip pen, mechanical pencil, clutch pencil. The two grip members are detachably connected to each other, thus allowing various combinations of pen types to be realized.

A threaded connection between the two grip members results in a connection that is detachable particularly easily, thus allowing the user to disassemble and reassemble the writing implement on his/her own so as to produce in particular new pen type combinations.

A connection element being arranged between the two grip members by means of which the two grip members are interconnected simplifies the production of the casing parts of the writing implement. The connection element can be screwed with the associated casing components of the writing implement.

A symmetric design of the connection element, in which the writing implement is configured symmetrically, simplifies the production thereof and facilitates the assembly of the writing implement configured as a double-tip pen. A symmetric design of the connection element is provided if the three-dimensional shape thereof can be transformed into itself by a rotation of 180° about an axis perpendicular to a longitudinal axis of a basic sleeve shape of the connection element.

Another object of the present invention is to provide a kit for a writing implement.

This object is achieved by a kit consisting of at least one writing implement comprising a casing body, a grip member connected to the casing body, a writing tip arranged on the grip member, and a protective cap, wherein the casing body has an externally threaded portion for screwing down the protective cap into a writing position, and an internally threaded portion to be connected to the grip member, and an intermediate piece having a length is provided for extending a length of the writing implement between the casing body and the grip member, the intermediate piece being connectable to the casing body and to the grip member, at least another casing body and/or at least another grip member and/or at least another intermediate piece and/or at least another protective cap and/or at least another connection element and/or at least one covering cap. A kit according to the invention guarantees an individual adjustment of the writing implement. Preferably, the individual components differ from each other in terms of their length, material, color, surface structure, optically, haptically and/or in terms of their external shape. This provides various possibilities of individualizing the writing implement. Depending on the design of the writing implement, an intuitive disassembly and reassembly thereof may be possible.

In a set comprising at least two different intermediate pieces, the individual adjustment of the writing implement is improved even more.

In an advantageous embodiment, the at least two intermediate pieces differ in terms of their shape, material, surface structure, color, optically, haptically and/or in terms of their external shape.

Exemplary embodiments shall be explained in more detail with reference to the FIGS. 1 to 13.

### BRIEF DESCRIPTION OF THE DRAWINGS

FIG. 1 shows an exploded view of the writing implement 1 with a protective cap in a protective position;

FIG. 2 shows a sectional view of the protective cap according to FIG. 1;

FIG. 3 shows a sectional view of the grip member according to FIG. 1;

FIG. 4 shows a sectional view of the intermediate piece according to FIG. 1;

FIG. 5 shows a sectional view of the casing body according to FIG. 1;

FIG. 6 shows a side view of a writing implement according to FIG. 1 in the assembled state;

FIG. 7 shows a side view of another embodiment of a writing implement, configured as a double-tip pen, in the assembled state;

FIG. 8 shows the writing implement according to FIG. 7 with the protective caps removed on both sides;

FIG. 9 shows a connection element for connecting grip members of two writing tips of the writing implement according to FIGS. 7 and 8, the connection element also being shown in a side view;

FIG. 10 shows a partial pen of the double-tip pen according to FIGS. 7 and 8 after removing the connection element according to FIG. 9 at least on one side and screwing on a protective cap instead, the partial pen also being shown in a side view in the assembled state;

FIG. 11 shows the partial pen according to FIG. 10 with its protective cap removed;

FIG. 12 shows another embodiment of a double-tip pen in a view similar to FIG. 7, the double-tip pen according to FIG. 12 not being provided with a separate connection element as the one shown in FIG. 9; and

FIG. 13 shows the double-tip pen according to FIG. 12 with its protective caps removed.

### DETAILED DESCRIPTION

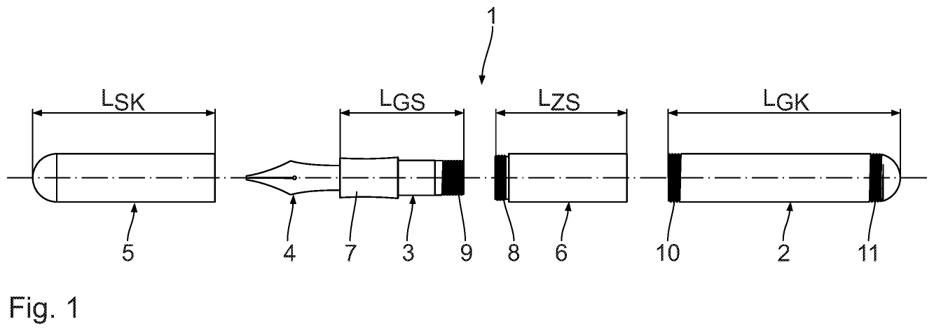

FIG. 1 shows a writing implement 1 configured as a fountain pen. The writing implement 1 is made of brass and has a smooth surface structure. The writing implement 1 comprises a cylindrical casing body (GK) 2, a cylindrical grip member (GS) 3 connected to the casing body 2, with a writing tip 4 arranged on the grip member 3, and a protective cap (SK) 5. The writing implement 1 further has an intermediate piece (ZS) 6 between the casing body 2 and the grip member 3, the intermediate piece 6 being connectable to the casing body 2 and the grip member 3.

In the configuration shown in FIG. 1, the protective cap 5 is in the protective position. To this end, the protective cap 5 is detachably connected to the intermediate piece 6 in such a way that both a holding portion 7 of the grip member 3 and the writing tip 4 are covered, and therefore protected, by the protective cap 5. For this purpose, the protective cap 5 is screwed on an externally threaded portion 8 of the intermediate piece 6. The grip member 3 is detachably connected to the intermediate piece 6. For this purpose, the intermediate piece 6 is screwed on an externally threaded portion 9 of the grip member 3. The intermediate piece 6 is again detachably connected to the casing body 2. To this end, the intermediate piece 6 is screwed on a first externally threaded portion 10 of the casing body 2.

In a configuration not shown, the protective cap 5 is in a writing position, the protective cap 5 is detachably connected to the casing body 2. To this end, the protective cap 5 is screwed on a second externally threaded portion 11 of the casing body 2.

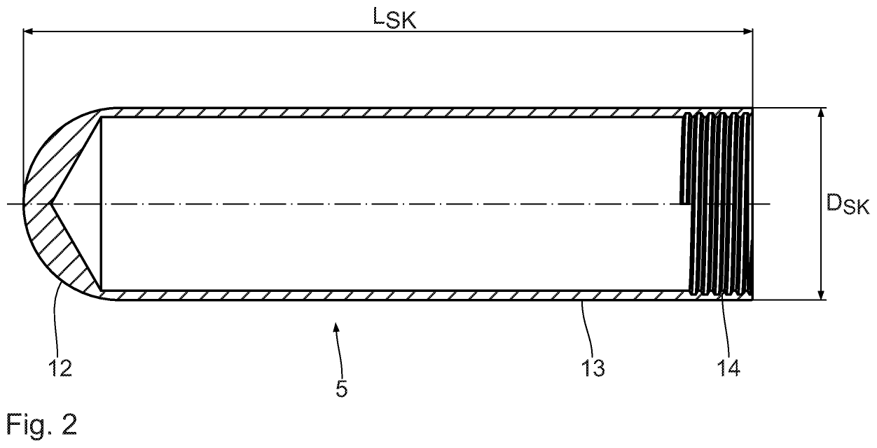

FIG. 2 shows a sectional view of the protective cap 5. The protective cap 5 has a cylindrical shape with a closed end 12 and an open end 13. The protective cap 5 further has a length L_{SK} and a diameter D_{SK}. The length L_{SK} is preferably 47 mm. The closed end 12 is configured in the shape of a dome. The dome-shaped end 12 preferably has a radius of 6.8 mm. The diameter D_{SK} is preferably 12.4 mm. The open end 13 is provided with an internally threaded portion 14. When the protective cap 5 is in the protective position, the internally threaded portion 14 engages the externally threaded portion 8 of the intermediate piece 6. When the protective cap 5 is in the writing position, the internal thread 14 engages the second externally threaded portion 11 of the casing body 2.

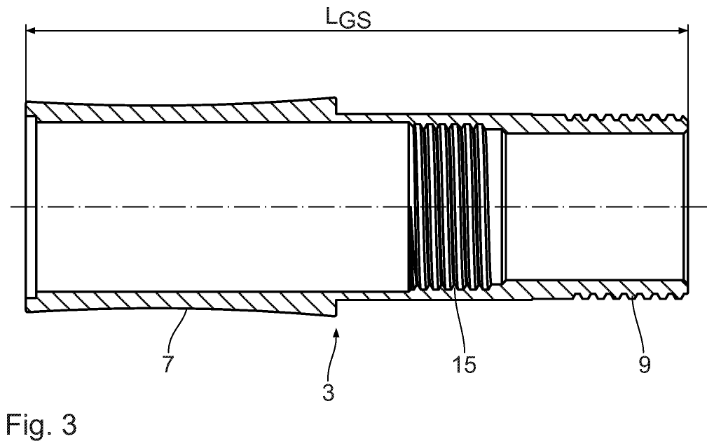

FIG. 3 shows a sectional view of the grip member 3. The grip member 3 has a length L_{GS}. The length L_{GS} is preferably 32 mm. The holding portion 7 is concave. In a region adjacent to the holding portion 7, the nib (not shown) is, with a writing tip 4, rigidly connected to the grip member 3. The external thread is arranged at the end opposite the writing tip 4. Furthermore an internally threaded portion 15 is provided for receiving the nib (not shown).

FIG. 4 shows a sectional view of the intermediate piece 6. The intermediate piece 6 is hollow cylindrical with a length L_{ZS} and a diameter D_{ZS}. The externally threaded portion 8 to be connected to the protective cap 5 in the protective position is provided at an end facing the grip member 3 (see FIG. 1). A first internally threaded portion 16 for receiving the externally threaded portion 9 of the grip member 7 is provided in the direction of an end facing the casing body 2 (see FIG. 1). A second internally threaded portion 17 to be connected to the casing body 2 is provided at the end facing the casing body 2. The length L_{LZ} may vary depending on the type. The minimum length L_{ZS} is obtained from the sum of the respective length of the externally threaded portion 8, the first internally threaded portion 16 and the second internally threaded portion 17. Advantageously the length L_{LZ} is 34 mm. The diameter D_{ZS} of the intermediate piece 6 is equal to the diameter D_{SK} of the protective cap 5.

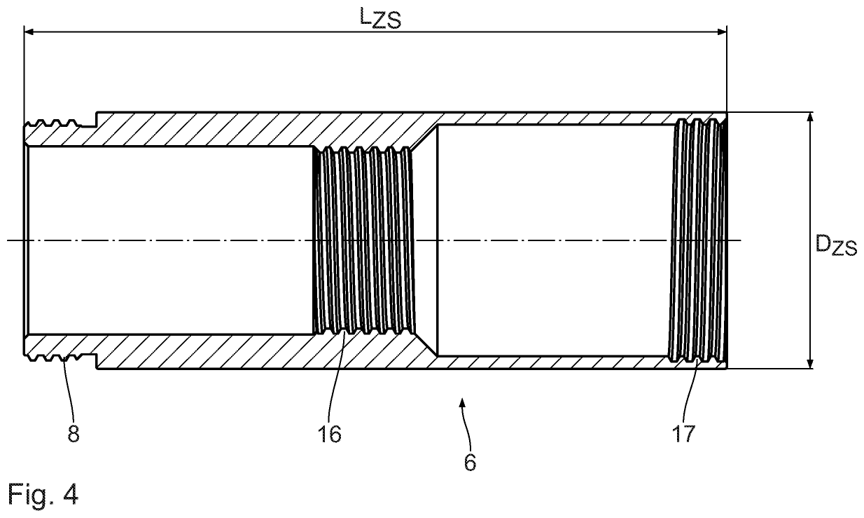

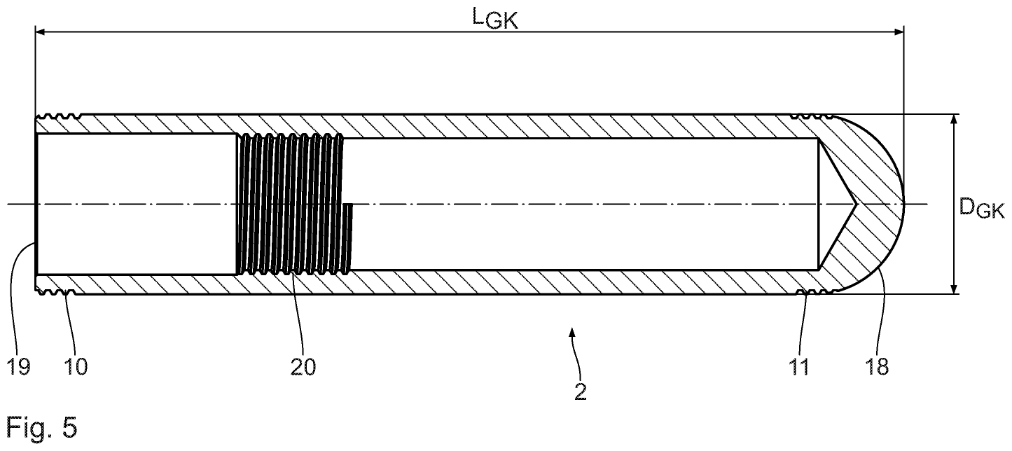

FIG. 5 shows a sectional view of the casing body 2. The casing body 2 is configured as a hollow cylindrical body with a closed end 18 and an open end 19. The open end 19 faces the intermediate piece 6 (see FIG. 1). The first externally threaded portion 10 is arranged at the open end 19. The first externally threaded portion 10 serves to engage the second internally threaded portion 17 of the intermediate piece 6. The closed end 18 is configured in the shape of a dome. At the closed end 18, the second externally threaded portion 11 for receiving the internally threaded portion 14 of the protective cap 5 in the writing position is disposed. Between the first externally threaded portion 10 and the second externally threaded portion 11, an internally threaded portion 20 is arranged. Via the internally threaded portion 20, the casing body 3 can be detachably connected to the grip member 3. To this end, the externally threaded portion 9 of the grip member 3 engages the internally threaded portion 20 of the casing body 2. Connecting the casing body 2 to the grip member 3 is necessary in particular if no intermediate piece 6 is provided between the grip member 3 and the casing body 2. The casing body 2 further has a length L_{GK} and a diameter D_{GK}. The length L_{GK} is preferably 56 mm. The diameter D_{GK} of the casing body 2 is smaller than the diameter D_{ZS} of the intermediate piece 6 and the diameter D_{SK} of the protective cap 5.

Alternatively the diameter D_{GK} of the casing body 2 may correspond to the diameters D_{ZS} of the intermediate piece 6 and D_{SK} of the protective cap 5. In this case, it must be observed, however, that the first externally threaded portion 10 and the second externally threaded portion 11 each have an identical diameter that is smaller than the diameters D_{ZS} of the intermediate piece 6, D_{GK} of the casing body 2 and D_{SK} of the protective cap 5.

The internally threaded portions 14, 15, 16, 17 and 20 as well as the externally threaded portions 8, 9, 10 and 11 are configured equally, thus resulting in further combination possibilities in order to assemble the writing implement 1 in different ways.

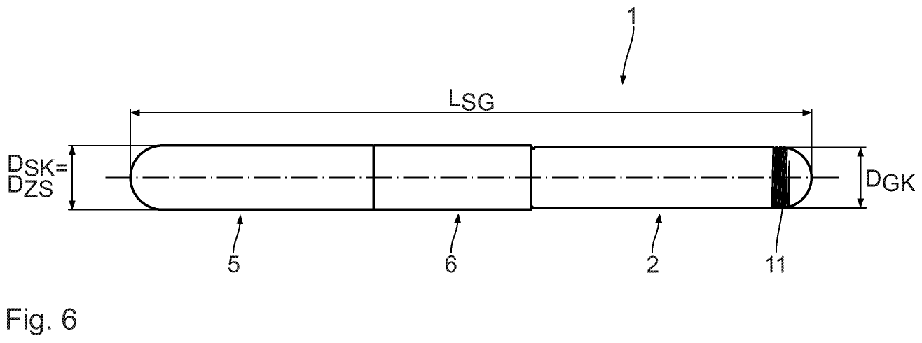

FIG. 6 shows an assembled view of the writing implement 1 in a preferred configuration with a length L_{SG}, with the protective cap 5 being disposed in the protective position. The intermediate piece 6 is disposed between the protective cap 5 and the grip member 2.

Another preferred configuration (not shown) of the writing implement 1 shall hereinafter be described in more detail. In this configuration, the intermediate piece 6 is arranged between the casing body 2 and the protective cap 5 in the writing position. To this end, the intermediate piece 6 is screwed across the second internally threaded portion 17 onto the second externally threaded portion 11 of the casing body 2, and the protective cap 5 is screwed across the internally threaded portion 14 onto the externally threaded portion 8 on the intermediate piece 6, causing the center of gravity of the writing implement 1 to move in the direction of the protective cap 5 in the writing position.

In another embodiment, a plurality of intermediate pieces 6 are provided, with at least two intermediate pieces 6 being arranged adjacent to each other. The intermediate pieces 6 are configured identically. In order to connect at least two intermediate pieces 6, the externally threaded portion 8 engages the second internally threaded portion 17 of the intermediate piece 6 arranged adjacent thereto.

In another embodiment, the casing body of the writing implement is formed by a second writing tip with an associated protective cap. A writing implement of this type is then provided with writing tips at both ends, thus allowing both writing tips to be used selectively after removing the respective protective cap.

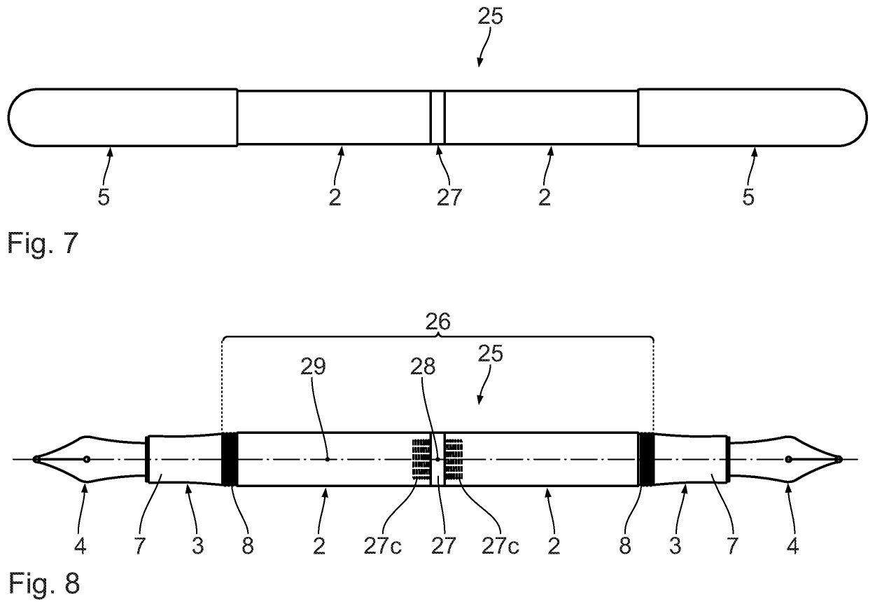

Two embodiments of a writing implement of this type having a second writing tip with an associated protective cap shall be described hereinafter with reference to FIGS. 7 to 9 as well as 12 and 13; these embodiments are hereinafter also referred to as double-tip pen. Components and functions that correspond to those already described above with reference to FIGS. 1 to 6 are designated by the same reference numerals and are not discussed in detail again.

A writing implement 25 configured as a double-tip pen according to FIGS. 7 and 8 has a casing body 26 composed of multiple parts, with a respective writing tip 4 being connected thereto on either side via grip members 3. In other words, the writing implement 25 has two grip members 3 connected to each other, with each of the grip members 3 being provided with a respective one of the writing tips 4. The two grip members 3 are screwed together by means of the casing body 26. The casing body 26 has two casing body parts configured in the manner of the casing bodies 2 of the embodiment according to FIGS. 1 to 6, the casing body parts being interconnected by a central connection element 27. This interconnection of the two casing body parts 2 is carried out by screwing the casing body parts 2 to the connection element 27.

A base body 27a of the connection element 27, which forms a seamless extension of a casing of the writing implement 25 between the two casing body parts 2, is provided with two external threads 27b on each of its two sides. When the double-tip pen is assembled, these two external threads 27b are screwed into internal threads 27c, complementary thereto, of the casing body parts 2, said internal threads 27c being outlined in FIG. 8.

The entire writing implement 25 is configured symmetrically in such a way that the three-dimensional shape thereof is transformable into itself by a rotation of 180° about an axis 28 perpendicular to a longitudinal axis 29 of a basic sleeve shape of the writing implement 25. In other words, the two casing body parts 2, the two grip members 3 and the two writing tips 4 of the writing implement 25 are configured identically to each other. Particularly when it comes to details such as shape, colors and type of the writing tips, this identity is not obligatory so one of the writing tips may for instance be configured as a nib while another of the writing tips may be configured as a ballpoint pen. Other combinations corresponding to the possibilities for the writing tip discussed above are conceivable as well.

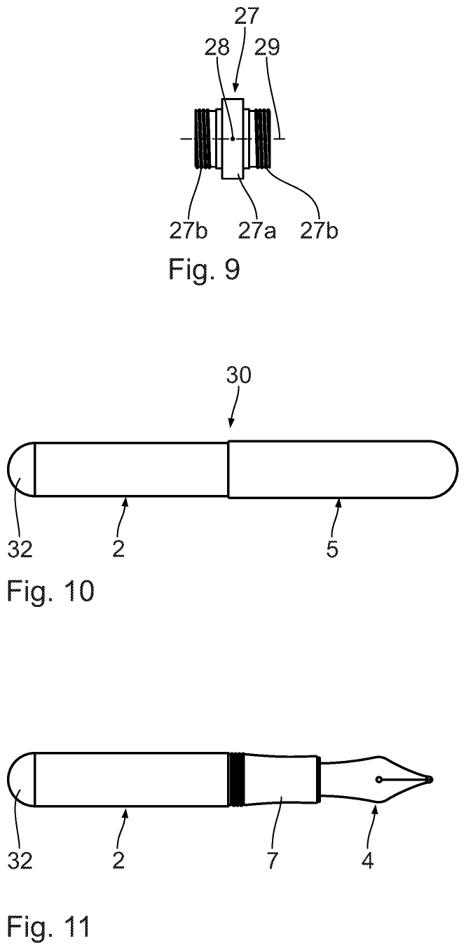

Corresponding to the three-dimensional symmetry of the writing implement 25 as a whole explained above, the connection element 27 is configured symmetrically as well, in other words it is transformable into itself by a rotation of 180° about the axis 28 (see FIG. 9), which is perpendicular to the longitudinal axis 29 of the basic sleeve shape of the connection element 27.

The writing implement 25 is a variation of the writing implement 1 according to FIGS. 1 and 6 comprising an intermediate piece for extending a length of the writing implement between a casing body and a grip member. The intermediate piece may be one of the casing body parts 2 and the connection element 27, which extends a length of the entire writing implement between the other casing body part 2 and the grip member 3 arranged opposite thereto. The second writing end, which is currently not being used during writing, of the writing implement 25 configured as a double-tip pen leads to an extension, shown in FIGS. 10 and 11, of a single-tip pen basis 30 that can be assembled from the double-tip pen according to FIGS. 7 to 9 so as to improve the writing ergonomics as well as the handling of the writing implement. The writing implement 25, in other words the original double-tip pen, can be disassembled into two single-tip pens 30 of this type in which the threaded connection between the connection element 27 and the two casing body parts 2 is in each case released and a covering cap 32 is screwed into the associated internal threads of the casing body parts 2. The basic shape of the casing body 2 of the single-tip pen 30 including the covering cap 32 then corresponds to the basic shape of the casing body 2 of the writing implement 1 again.

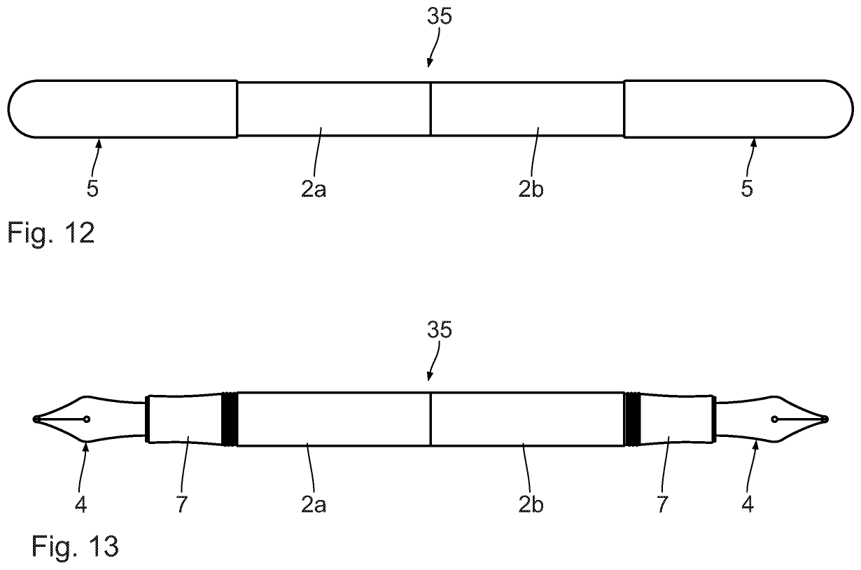

Another embodiment of a writing implement 35 configured as a double-tip pen will hereinafter be described with reference to FIGS. 12 and 13. Components and functions that correspond to those already explained above with reference to FIGS. 1 to 11 and in particular with reference to FIGS. 7 to 9 are designated by the same reference numerals and are not discussed in detail again.

In the writing implement 35, a connection element in the manner of the connection element 27 is omitted. There, the two casing body parts, which are referred to as 2a and 2b in FIGS. 12 and 13, are directly connected to each other. This may for instance be carried out in such a way that a base body of the casing body part 2a is provided with an external thread in the manner of the external thread 27b, with the casing body part 2b then being configured in the manner of the casing body part 2 of the writing implement 25 so the two casing body parts 2a, 2b are interconnected by screwing the external thread 27b of the casing body part 2a with the internal thread 27c, complementary thereto, of the casing body part 2b. Otherwise, the writing implement 35 corresponds to the writing implement 25.

The casing bodies, grip members, intermediate pieces, connection elements and protective caps of the writing implement embodiments described above may be made of metal and/or plastic material. The metal may be brass.

1.-11. (canceled)

12. A writing implement, comprising:
a casing body;
a grip member connected to the casing body;
a writing tip arranged on the grip member; and
a protective cap,
wherein the casing body has
an externally threaded portion for screwing down the protective cap into a writing position and
an internally threaded portion to be connected to the grip member, and
wherein an intermediate piece having a length (L_{ZS}) is provided for extending a length of the writing implement between the casing body and the grip member, the intermediate piece being connectable to the casing body and to the grip member.

13. The writing implement according to claim 12, wherein the length (L_{ZS}) of the intermediate piece is at least 10% of a length (L_{GK}) of the casing body.

14. The writing implement according to claim 13, wherein
the casing body has a diameter (D_{GK});
the protective cap has a diameter (D_{SK}); and
the at least one intermediate piece has a diameter (D_{ZS}), and
wherein the following applies: D_{GK}<D_{ZS}, and D_{SK}=D_{ZS}.

15. The writing implement according to claim 12, wherein the intermediate piece has
a first internally threaded portion to be connected to the grip member;
a second internally threaded portion, arranged opposite to the first internally threaded portion, to be connected to the casing body; and
an externally threaded portion to be connected to the protective cap in a protective position or another intermediate piece.

16. The writing implement according to claim 12, wherein the casing body has a first externally threaded portion for screwing up the protective cap into a protective position, wherein the externally threaded portion for screwing down the protective cap into a writing position is a second externally threaded portion arranged opposite the first externally threaded portion.

17. A writing implement, comprising
a casing body, with a respective writing tip being connected to each of its two sides,
wherein the writing implement has two detachably connected grip members, with each of the grip members being provided with a respective one of the writing tips.

18. The writing implement according to claim 17, wherein the two grip members are interconnected using threaded connections.

19. The writing implement according to claim 17, wherein a connection element is arranged between the two grip members by means of which the two grip members are interconnected.

20. The writing implement according to claim 19, wherein the writing implement is configured symmetrically.

21. A kit consisting of at least one writing implement comprising
a casing body;
a grip member connected to the casing body;
a writing tip arranged on the grip member; and
a protective cap,
wherein the casing body has
an externally threaded portion for screwing down the protective cap into a writing position and
an internally threaded portion to be connected to the grip member, and
wherein an intermediate piece having a length (L_{ZS}) is provided for extending a length of the writing implement between the casing body and the grip member, the intermediate piece being connectable to the casing body and to the grip member,
further comprising at least one of
at least another casing body,
at least another grip member,
at least another intermediate piece,
at least another protective cap,
at least another connection element,
at least one covering cap.

22. The kit according to claim 21, comprising at least two different intermediate pieces.
